(19) United States
(12) Patent Application Publication
(10) Pub. No.: US 2026/0357754 A1
(43) Pub. Date: Nov. 12, 2026

(54) PROPULSION SYSTEM

(71) Applicant: IHI Corporation, Tokyo (JP)

(72) Inventors: Yoshihiro KISHINO, Tokyo (JP); Toru KUGA, Tokyo (JP)

(73) Assignee: IHI Corporation, Tokyo (JP)

(21) Appl. No.: 19/719,539

(22) Filed: Jun. 25, 2026

Related U.S. Application Data
(63) Continuation of application No. PCT/JP2025/000794, filed on Jan. 14, 2025.

(30) Foreign Application Priority Data
Feb. 15, 2024 (JP) 2024-021160

(51) Int. Cl. F02C 7/236; B64G 1/40; F02C 7/264; F02K 9/62

(52) U.S. Cl. CPC F02C 7/236; F02C 7/264; B64G 1/40; F02K 9/62; F05D 2260/42

(57) ABSTRACT

A propulsion system includes: a main combustion chamber and a supply system that supplies fuel and an oxidizer to the main combustion chamber. The supply system includes: a first pump that draws in fuel and pressure-feeds it to the supply system; a second pump that draws in an oxidizer and pressure-feeds it to the supply system; a generator including a turbine driven by supply of a working fluid; a power storage device that stores electric power generated by the generator; a first electric motor that drives the first pump with electric power from the power storage device; and a second electric motor that drives the second pump with electric power from the power storage device.

### CROSS REFERENCE TO RELATED APPLICATIONS

This application is a continuation application of International Application No. PCT/JP2025/000794, now WO 2025/173444A1, filed on Jan. 14, 2025, which claims priority to Japanese Patent Application No. 2024-021160, filed on Feb. 15, 2024, the entire contents of which are incorporated by reference herein.

### TECHNICAL FIELD

The present disclosure relates to a propulsion system mounted on a spacecraft or rocket.

### BACKGROUND

A bipropellant propulsion system for a spacecraft or rocket generates thrust by combusting a fuel and an oxidizer. Inside the propulsion system, these propellants are supplied to a combustion chamber by turbopumps and burned. The turbine of the turbopump is driven by the supply of hot gas, which is the working fluid of the turbine. The hot gas is either the combustion gas of the fuel and oxidizer, or the gasified fuel during regenerative cooling. Which gas is generated depends on the operating cycle of the propulsion system. For example, in a gas generator (GG) cycle, hot gas is obtained by combustion of fuel and oxidizer using a gas generator (see Patent Literature: JP 2007-218899 A). In an expander cycle, it is obtained by vaporization of liquid fuel in the regenerative cooling of the nozzle and combustion chamber.

### SUMMARY OF THE INVENTION

In any operating cycle, two pumps for propellants are driven by either a single common turbine or by individual turbines. The pumps and turbines are drivingly connected to each other via a rotating shaft (drive shaft), and they rotate integrally at the same rotational speed.

In general, however, the optimal rotational speeds for the fuel pump and the oxidizer pump differ from each other. Moreover, the optimal rotational speeds for a pump and the turbine that drives that pump also differ. Therefore, conventional configurations cannot simultaneously optimize the efficiencies of both the pump and the turbine. For example, when it is desired to decrease the thrust, the amount of propellant supplied must be reduced. However, the rotational speed of the turbine must be maintained at or above a predetermined value so that the efficiency and output of the turbine do not drop excessively. Consequently, as the thrust is progressively reduced, the rotational speed (output) of the pump increases excessively, thereby reducing the overall efficiency of the propulsion system.

The present disclosure has been made in view of such circumstances, and an object thereof is to provide a propulsion system capable of operating efficiently in response to various thrust levels.

A propulsion system according to one aspect of the present disclosure includes: a main combustion chamber, and a supply system configured to supply fuel and an oxidizer to the main combustion chamber, wherein the supply system includes: a first pump that draws in the fuel and pressure-feeds it to the supply system; a second pump configured to draw in the oxidizer and pressure-feeds it to the supply system; a first generator including a turbine driven by supply of a first working fluid; a power storage device configured to store electric power generated by the first generator; a first electric motor configured to drive the first pump with electric power from the power storage device; and a second electric motor configured to drive the second pump with electric power from the power storage device.

The first generator may be a motor-generator that also serves as a second electric motor. In this case, the first pump is drivingly connected to the first turbine of the first generator. The propulsion system may include a sub-combustion chamber configured to generate the first working fluid from the fuel and the oxidizer. The first working fluid may be the fuel that has passed through regenerative cooling of the main combustion chamber. The propulsion system may include a supply amount adjustment unit configured to adjust the amount of supply of the first working fluid to the first turbine in accordance with a power generation amount set for the first generator. Control of ignition of the first sub-combustion chamber may be performed independently of the timing of ignition of the main combustion chamber. The supply system may include: a second sub-combustion chamber configured to generate a second working fluid from the fuel and the oxidizer; and a second generator including a second turbine driven by supply of the second working fluid; and the power storage device may further store electric power generated by the second generator.

According to the present disclosure, it is possible to provide a propulsion system capable of operating efficiently in response to various thrust levels.

### BRIEF DESCRIPTION OF THE DRAWINGS

FIG. 1 is a schematic configuration diagram of a propulsion system according to a first embodiment of the present disclosure.

FIG. 2 is a diagram showing an example of an operating sequence of the propulsion system.

FIG. 3 is a diagram showing changes in efficiency with respect to thrust.

FIG. 4 is a schematic configuration diagram of a propulsion system according to a second embodiment of the present disclosure.

FIG. 5 is a schematic configuration diagram of a propulsion system according to a third embodiment of the present disclosure.

FIG. 6 is a schematic configuration diagram of a propulsion system according to a fourth embodiment of the present disclosure.

FIG. 7 is a schematic configuration diagram of a propulsion system according to a fifth embodiment of the present disclosure.

FIG. 8 is a schematic configuration diagram of a propulsion system according to a sixth embodiment of the present disclosure.

FIG. 9 is a schematic configuration diagram of a propulsion system according to a seventh embodiment of the present disclosure.

FIG. 10 is a schematic configuration diagram of a propulsion system according to an eighth embodiment of the present disclosure.

### DESCRIPTION OF EMBODIMENTS

Hereinafter, a propulsion system according to embodiments of the present disclosure will be described with reference to the drawings. Note that common parts in each drawing are denoted by the same reference numerals, and redundant descriptions are omitted. The propulsion system according to the embodiments is a bipropellant propulsion system that combusts a mixed gas of an oxidizer such as liquid oxygen and a fuel such as liquid hydrogen or liquefied hydrocarbon (e.g., liquefied methane), and is mounted on a spacecraft (e.g., an artificial satellite) or a rocket. Hereinafter, for convenience of description, the oxidizer and the fuel may be collectively referred to as propellants.

### First Embodiment

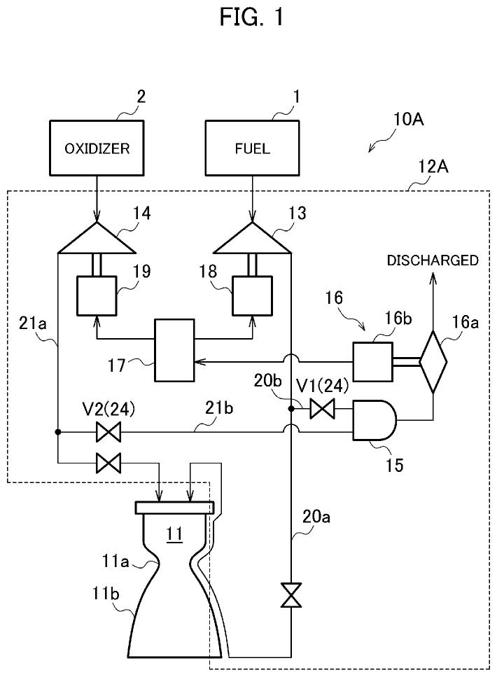

FIG. 1 is a schematic configuration diagram of the propulsion system 10A according to the first embodiment. As shown in FIG. 1, the propulsion system 10A includes a main combustion chamber 11 and a supply system (power pack) 12A that supplies fuel and an oxidizer to the main combustion chamber 11. The supply system 12A includes a first pump 13, a second pump 14, a sub-combustion chamber (first sub-combustion chamber) 15, a generator 16, a power storage device 17, a first electric motor 18, and a second electric motor 19. The propulsion system 10A adopts a gas generator (GG) cycle as an example of an operating cycle. Therefore, the sub-combustion chamber 15 of the present embodiment is a so-called gas generator.

The first pump 13 and the second pump 14 are, for example, centrifugal pumps having impellers (wheels). The first pump 13 and the second pump 14 are provided separately and are driven by corresponding electric motors (a first electric motor 18 or a second electric motor 19, described later). The first pump 13 and the second pump 14 can operate independently, and their respective rotational speeds are set independently. The first pump 13 and the second pump 14 are physically (mechanically) isolated from each other. Therefore, supply of inert gas (so-called purge gas), which is required in a single-shaft turbopump, is unnecessary. Consequently, the inert gas supply equipment can be omitted.

The first pump 13 draws in fuel stored in a fuel tank 1 and discharges (i.e., pressure-feeds) the fuel after boosting its pressure. Most of the fuel discharged from the first pump 13 is supplied to the main combustion chamber 11 via a path 20a through regenerative cooling of the nozzle 11b and the main combustion chamber 11. The remainder is supplied to the sub-combustion chamber 15 via a path 20b branching off from the path 20a.

The second pump 14 draws in an oxidizer stored in an oxidizer tank 2 and discharges (i.e., pressure-feeds) the oxidizer after boosting its pressure. Most of the oxidizer discharged from the second pump 14 is supplied to the main combustion chamber 11 via a path 21a, and the remainder is supplied to the sub-combustion chamber 15 via a path 21b branching off from the path 21a.

The main combustion chamber 11 of the present embodiment combusts a mixed gas of the fuel discharged from the first pump 13 and the oxidizer discharged from the second pump 14. The combustion gas of the main combustion chamber 11 is accelerated while expanding, and is discharged from the nozzle 11b through the throat 11a. The thrust of the propulsion system 10A is generated by the reaction of this combustion gas injection, in the same manner as a conventional propulsion system.

The sub-combustion chamber 15 also combusts a mixed gas of fuel and oxidizer. The combustion gas of the sub-combustion chamber 15 is supplied to a turbine (first turbine) 16a of the generator 16. By this supply of combustion gas, the turbine 16a rotates. That is, the sub-combustion chamber 15 generates a working fluid (first working fluid) for the turbine 16a from the fuel and the oxidizer. The combustion gas that has passed through the turbine 16a is discharged to the outside of the spacecraft or rocket on which the propulsion system 10A is mounted.

The amount of combustion gas supplied by the sub-combustion chamber 15 depends on the amount of fuel and oxidizer supplied to the sub-combustion chamber 15. The amounts of fuel and oxidizer supplied are adjusted by a supply amount adjustment unit 24 in accordance with a power generation amount set for the generator 16. The supply amount adjustment unit 24 is constituted by, for example, valves V1 and V2, which are flow rate adjustment valves. Valve V1 is provided on the fuel path 20b leading to the sub-combustion chamber 15, and valve V2 is provided on the oxidizer path 21b leading to the sub-combustion chamber 15. The opening degrees of these valves are controlled by a control unit (not shown) that comprehensively controls the propulsion system 10A.

The generator 16 includes the turbine 16a described above and a power generation unit 16b having a rotor and a stator. The turbine 16a is drivingly connected to the rotor of the power generation unit 16b. That is, the rotation shaft of the turbine 16a is directly or indirectly connected to the rotation shaft of the rotor so that the rotational force of the turbine 16a is transmitted to the rotor.

When the turbine 16a rotates due to the supply of combustion gas, the rotor of the power generation unit 16b rotates. As a result, the power generation unit 16b generates AC power corresponding to the rotational speed of the turbine 16a. The generated AC power is converted to DC power by a converter (not shown). This DC power is stored in the power storage device 17. Alternatively, the DC power is supplied to the first electric motor 18 and the second electric motor 19 via an inverter (not shown).

The power storage device 17 includes a battery (not shown) and a control circuit (not shown) for the battery, and stores the electric power generated by the generator 16. That is, the power storage device 17 is configured to be capable of storing electric power generated by the generator 16. As described above, the electric power stored in the power storage device 17 is supplied to the first electric motor 18 and the second electric motor 19.

The first electric motor 18 is drivingly connected to the first pump 13. That is, the rotation shaft of the first electric motor 18 is directly or indirectly connected to the rotation shaft of the first pump 13 so that the rotational force of the first electric motor 18 is transmitted to the first pump 13. In other words, the first pump 13 is an electric pump. Note that the electric power and waveform supplied to the first electric motor 18 are controlled by an inverter (not shown).

The second electric motor 19 is drivingly connected to the second pump 14. That is, the rotation shaft of the second electric motor 19 is directly or indirectly connected to the rotation shaft of the second pump 14 so that the rotational force of the second electric motor 19 is transmitted to the second pump 14. In other words, similarly to the first pump 13, the second pump 14 is also an electric pump. The electric power and waveform supplied to the second electric motor 19 are also controlled by an inverter (not shown).

Next, an example of a thrust change by the propulsion system 10A will be described. In this example, the thrust increases from 0% to 100%. The 100% thrust is maintained for a certain period of time, and then the thrust is gradually reduced in stages to a value below 10%. Finally, the thrust is set to 0%, and a series of operations related to thrust generation ends.

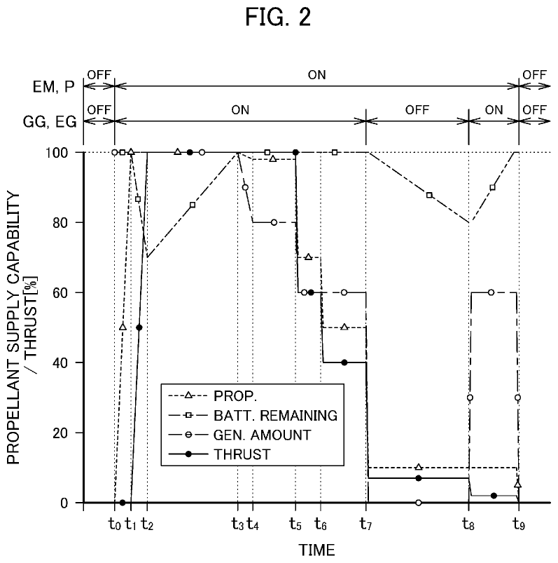

FIG. 2 is a diagram showing an example of an operating sequence of the propulsion system 10A in the example described above. Specifically, FIG. 2 shows, in time series, changes in: the propellant supply capability by the first pump 13 and the second pump 14 to the main combustion chamber 11 and the sub-combustion chamber 15; the power generation capability of the generator 16; the remaining battery charge in the power storage device 17; and the thrust of the propulsion system 10A. The upper part of the figure shows the respective operating statuses of the first electric motor 18 and the second electric motor 19 (denoted as EM), the first pump 13 and the second pump 14 (denoted as P), the sub-combustion chamber 15 (denoted as GG), and the generator 16 (denoted as EG).

The propulsion system 10A is stopped until time t₀. Therefore, the propellant supply capability, power generation capability, and thrust at this point are all 0%. Meanwhile, the remaining battery charge is 100%. Then, at time t₀, the propulsion system 10A begins its thrust-related operation. Specifically, the first electric motor 18 begins operating on the electric power of the power storage device 17 and drives the first pump 13. Also, the second electric motor 19 begins operating on the electric power of the power storage device 17 and drives the second pump 14. Consequently, supply of propellant to the main combustion chamber 11 and the sub-combustion chamber 15 is initiated. At this point, the substantial driving energy of the first pump 13 and the second pump 14 is only the electric power that drives the first electric motor 18 and the second electric motor 19.

Thereafter, the rotational speeds of the first pump 13 and the second pump 14 increase, and at time t₁ the propellant supply capability reaches 100%. Then, at time t₂, the main combustion chamber 11 and the sub-combustion chamber 15 are ignited. The thrust rises to 100% due to combustion in the main combustion chamber 11. Also, as the sub-combustion chamber 15 begins to operate, combustion gas from the sub-combustion chamber 15 is supplied to the turbine 16a of the generator 16.

At the initial stage of operation of the propulsion system 10A, the first electric motor 18 and the second electric motor 19 operate solely on the electric power from the power storage device 17 and drive the first pump 13 and the second pump 14. As a result, propellant is supplied to the main combustion chamber 11 and the sub-combustion chamber 15, and each is ignited. The order of ignition at this time is arbitrary. That is, control of ignition of the sub-combustion chamber 15 is performed independently of the timing of ignition of the main combustion chamber 11.

In conventional propulsion systems, propellant is supplied to the main combustion chamber by driving the turbopump using combustion gas from the sub-combustion chamber. Therefore, it is necessary to ignite the main combustion chamber after igniting the sub-combustion chamber. However, in the present embodiment, each pump is driven by an electric motor, and the electric motor is driven by battery power. That is, the combustion gas from the sub-combustion chamber is not required to drive each pump. Consequently, the order of ignition of the main combustion chamber 11 and the sub-combustion chamber 15 can be set arbitrarily. Furthermore, compared to a turbopump turbine, an electric motor has better responsiveness. Therefore, rotational speed overshoot (i.e., a state in which the rotational speed temporarily exceeds or falls short of the target) is less likely to occur, reducing the load on the pump.

By increasing the amount of propellant supplied to the sub-combustion chamber 15, the amount of combustion gas generated by the sub-combustion chamber 15 also increases. Consequently, the rotational speed of the turbine 16a also rises, and the electric power generated by the power generation unit 16b increases. The generated electric power is charged to the power storage device 17 (battery), replenishing the amount of electric power consumed up

### To Time T₂.

Charging continues thereafter, and at time t₃ the remaining battery charge reaches 100%. Thereafter, while the 100% thrust is maintained, the amount of propellant supplied to the sub-combustion chamber 15 is slightly reduced (by about 2%, for example). From time t₄ onward, the power generation amount of the generator 16 decreases to, for example, 80%. This suppresses excessive consumption of propellant while maintaining charging of the power storage device 17 (battery).

When reducing the thrust, the rotational speeds of the first electric motor 18 and the second electric motor 19 are decreased. As a result, the rotational speeds of the first pump 13 and the second pump 14 decrease, and the amount of propellant supplied to the main combustion chamber 11 decreases. In the example shown in FIG. 2, the thrust is set to 60% at time t₅, and the thrust is set to 40% from time t₆.

In general, an electric motor is more efficient than a turbopump and has less variation in efficiency with respect to rotational speed. For example, the rotational speed of a turbopump must be set to a predetermined value or higher to prevent the efficiency and output of the turbine from dropping excessively. However, when an electric motor is used, there is no such concern.

Therefore, even after the thrust is reduced, the first electric motor 18 and the second electric motor 19 can efficiently consume the electric power stored in the power storage device 17. For example, while the generator 16 is operating (the period from time t₃ to time t₇ in the example of FIG. 2), the generated electric power can be used to drive the first electric motor 18 and the second electric motor 19, and to charge the power storage device 17. Furthermore, an electric motor has better responsiveness than a turbopump. Therefore, the optimal amount of propellant to be supplied to the main combustion chamber 11 can be set with various amounts of change and in a short time.

Also, in conventional propulsion systems, it is difficult to supply a very small amount of propellant to the main combustion chamber, and therefore it is relatively difficult to reduce the thrust. On the other hand, in the present embodiment, electric motors are used as the power source for each pump. Therefore, compared to conventional propulsion systems that use turbopumps, it is possible to obtain small thrust efficiently.

For example, as one example of a small thrust setting, consider setting the thrust to 7% from time t₇ onward. In this case, valves V1 and V2, which are the supply amount adjustment unit 24, stop the supply of propellant to the sub-combustion chamber 15 at time t₇. Consequently, the supply of combustion gas to the turbine 16a also stops, and the power generation by the generator 16 also stops. That is, the first electric motor 18 and the second electric motor 19 operate solely on the electric power from the power storage device 17.

From time t₇ onward, the first electric motor 18 and the second electric motor 19 drive the first pump 13 and the second pump 14 so as to obtain 7% thrust. The propellant supply capability at this time is, for example, 10%. The first pump 13 and the second pump 14 then supply to the main combustion chamber 11 an amount of propellant corresponding to the set thrust.

Regardless of the thrust setting value, if it is determined that charging of the power storage device 17 is necessary, the supply of propellant to the sub-combustion chamber 15 may be continued or resumed regardless of the combustion state of the main combustion chamber 11. For example, as shown in FIG. 2, assume that the thrust is changed from 7% to 2% at time t₈. If the remaining battery charge at this point drops below a predetermined threshold (for example, 80% as shown in FIG. 2) at which charging is determined to be necessary, valves V1 and V2, which are the supply amount adjustment unit 24, open.

Propellant is then supplied to the sub-combustion chamber 15, and combustion in the sub-combustion chamber 15 resumes. As a result, combustion gas from the sub-combustion chamber 15 is supplied to the turbine 16a, the generator 16 resumes power generation, and charging of the power storage device 17 resumes. On the other hand, the amount of propellant supplied to the main combustion chamber 11 does not increase. In other words, charging is carried out independently of thrust control.

When the remaining battery charge reaches 100% due to charging of the power storage device 17, the supply of propellant to the main combustion chamber 11 and the sub-combustion chamber 15 is stopped, and the thrust becomes 0% at time t₉. In the example of FIG. 2, the supply of propellant to the main combustion chamber 11 and the sub-combustion chamber 15 is stopped simultaneously. However, the stopping of propellant supply to the sub-combustion chamber 15 may be before or after stopping the supply of propellant to the main combustion chamber 11.

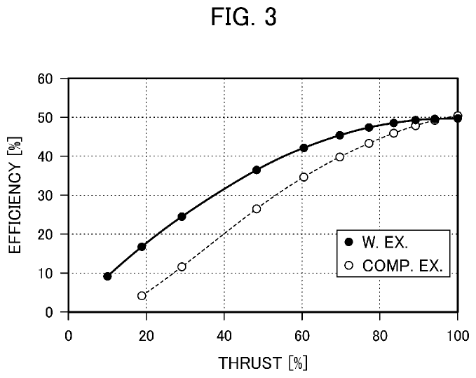

FIG. 3 is a diagram showing changes in efficiency with respect to thrust. The filled circles and solid line show the efficiency of the propulsion system 10A according to the present embodiment (working example), and the open circles and dashed line show the efficiency of a propulsion system using a turbopump as a comparative example. In calculating the efficiency of the propulsion system 10A, the efficiency of the first electric motor 18 and the second electric motor 19 was referenced from the efficiency of a general high-efficiency motor, and values ranging from 90% to 95% were used. Additionally, the generator 16 was assumed to operate in its most efficient state at each thrust level, and an efficiency of 75% was used.

As shown in FIG. 3, when the thrust is close to 100%, there is no significant difference in efficiency between the present embodiment and the comparative example. However, it can be seen that as the thrust decreases, the characteristics of the electric motors maintaining high efficiency become apparent, and efficiency improves compared to the comparative example. That is, according to the present embodiment, it is possible to provide a propulsion system 10A capable of operating efficiently in response to various thrust levels.

### Second Embodiment

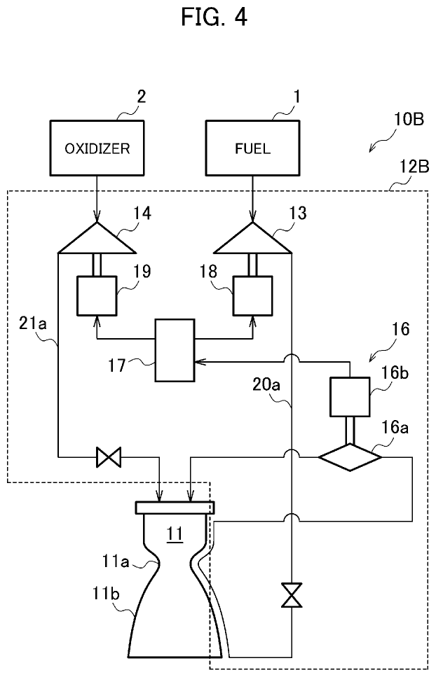

FIG. 4 is a schematic configuration diagram of the propulsion system 10B according to the second embodiment. As shown in FIG. 4, the propulsion system 10B includes a main combustion chamber 11 and a supply system 12B that supplies fuel and an oxidizer to the main combustion chamber 11. The supply system 12B includes a first pump 13, a second pump 14, a generator 16, a power storage device 17, a first electric motor 18, and a second electric motor 19.

The propulsion system 10B according to the present embodiment adopts an expander cycle (full expander cycle) as an example of an operating cycle. Therefore, the propulsion system 10B does not include the sub-combustion chamber 15 that was employed in the first embodiment. Instead, the fuel path 20a passes through thermal contact with the outer walls of the main combustion chamber 11, the throat 11a, and the nozzle 11b, and then passes through the turbine 16a of the generator 16. The path 20a that has passed through the turbine 16a ultimately connects to the main combustion chamber 11.

The fuel is discharged from the second pump 14 and cools the main combustion chamber 11, the throat 11a, and the nozzle 11b (i.e., performs regenerative cooling). The fuel that has undergone regenerative cooling (so-called hot gas) is supplied to the turbine 16a, causing the turbine 16a to rotate. That is, the fuel that has undergone regenerative cooling is the working fluid of the turbine 16a. The fuel that has passed through the turbine 16a is supplied to the main combustion chamber 11 and combusted therein together with the oxidizer.

In the second embodiment as well, the operating sequence shown in FIG. 2 can be executed. However, when thrust is being generated (i.e., when the main combustion chamber 11 is combusting), fuel always passes through the turbine 16a. Therefore, while thrust is being generated, the generator 16 continues to generate power. Also, the amount of fuel flowing through the turbine 16a varies according to the set thrust.

Consequently, the power generation amount of the generator 16 varies depending on the set thrust. However, despite such variation, for example, by ensuring a sufficient battery capacity in the power storage device 17, the first electric motor 18 and the second electric motor 19 can be driven at a desired rotational speed (e.g., an optimized rotational speed) over the entire thrust range. Also, as with the first embodiment, the improvement in efficiency shown in FIG. 3 can be achieved. Therefore, it is possible to provide a propulsion system 10B capable of operating efficiently in response to various thrust levels.

### Third Embodiment

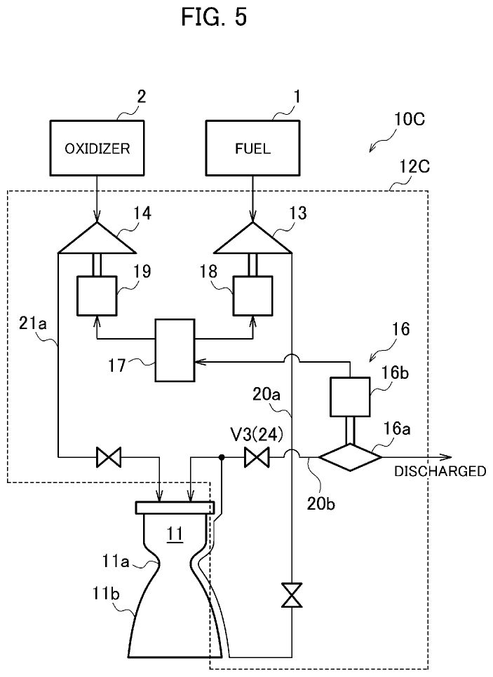

FIG. 5 is a schematic configuration diagram of the propulsion system 10C according to the third embodiment. As shown in FIG. 5, the propulsion system 10C includes a main combustion chamber 11 and a supply system 12C that supplies fuel and an oxidizer to the main combustion chamber 11. The supply system 12C includes a first pump 13, a second pump 14, a generator 16, a power storage device 17, a first electric motor 18, and a second electric motor 19.

The propulsion system 10C according to the present embodiment adopts an expander bleed cycle as an example of an operating cycle. Therefore, the supply system 12C includes a path 20b branching from the fuel path 20a that has undergone regenerative cooling. The fuel (i.e., hot gas) flowing through the path 20b is supplied to the turbine 16a via valve V1 serving as the supply amount adjustment unit 24. The fuel discharged from the turbine 16a is discharged to the outside of the spacecraft or rocket on which the propulsion system 10C is mounted.

As with the second embodiment, in the third embodiment as well, the operating sequence shown in FIG. 2 can be executed. However, it is possible to lower the back pressure of the turbine 16a more than in the second embodiment. Therefore, compared to the second embodiment, it becomes easier to increase the rotational speed of the turbine 16a, making it possible to improve the power generation performance of the generator 16 or to reduce the size of the generator 16. Also, as with the first and second embodiments, the improvement in efficiency shown in FIG. 3 can be achieved.

### Fourth Embodiment

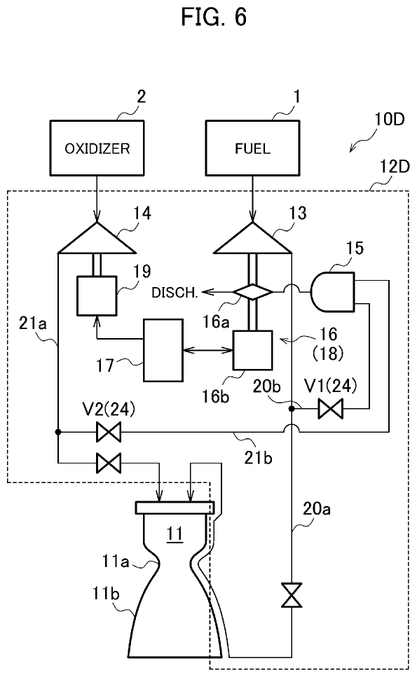

FIG. 6 is a schematic configuration diagram of the propulsion system 10D according to the fourth embodiment. As shown in FIG. 6, the propulsion system 10D includes a main combustion chamber 11 and a supply system 12D that supplies fuel and an oxidizer to the main combustion chamber 11. The supply system 12D includes a first pump 13, a second pump 14, a sub-combustion chamber (gas generator) 15, a generator 16, a power storage device 17, a first electric motor 18, and a second electric motor 19.

As with the first embodiment, the propulsion system 10D according to the fourth embodiment also adopts a gas generator (GG) cycle as an example of an operating cycle. Therefore, the combustion gas of the main combustion chamber 11 is ejected from the nozzle 11b. On the other hand, the combustion gas of the sub-combustion chamber 15 is supplied to the turbine 16a of the generator 16 and is then discharged to the outside of the spacecraft or rocket.

In the fourth embodiment as well, the operating sequence shown in FIG. 2 can be executed. However, the generator 16 in the fourth embodiment is a motor-generator that also serves as the first electric motor 18 that drives the first pump 13. Therefore, the turbine 16a is drivingly connected to the power generation unit 16b and the first pump 13.

When combustion gas from the sub-combustion chamber 15 is supplied to the turbine 16a, the turbine 16a rotates and drives the rotor of the power generation unit 16b and the first pump 13. As a result, the power generation unit 16b generates electric power, and the generated electric power is stored in the power storage device 17.

When electric power from the power storage device 17 is supplied to the power generation unit 16b, the rotor of the power generation unit 16b rotates and drives the first pump 13. As a result, the first pump 13 supplies fuel to the main combustion chamber 11 and the sub-combustion chamber 15. At this time, the sub-combustion chamber 15 does not generate combustion gas. That is, valves V1 and V2, which are the supply amount adjustment unit 24, are closed, and the supply of propellant to the sub-combustion chamber 15 is stopped.

However, the first pump 13 may be driven by both the turbine 16a and the power generation unit 16b. In this case, valves V1 and V2, which are the supply amount adjustment unit 24, open, propellant is supplied to the sub-combustion chamber 15, and the sub-combustion chamber 15 supplies its combustion gas to the turbine 16a.

In the present embodiment, the turbine 16a and the power generation unit 16b are used together as drive sources for the first pump 13 depending on the situation. For example, when a thrust of a predetermined value or higher is set, the sub-combustion chamber 15 ignites, and the turbine 16a is driven by the combustion gas of the sub-combustion chamber 15. Such operation applies, for example, during the period from time t₁ to t₅ when 100% thrust is set in the operating sequence of FIG. 2.

The driving of the first pump 13 by the turbine 16a assists the driving of the first pump 13 by the power generation unit 16b. In other words, the turbine 16a bears part of the energy required to drive the first pump 13. In general, the fuel pump has a larger output (pump capacity) than the oxidizer pump, and the drive source for it tends to be larger. In the present embodiment, this drive source is shared by two drive sources (i.e., the turbine 16a and the power generation unit 16b). As a result, the power generation unit 16b can be made more compact.

### Fifth Embodiment

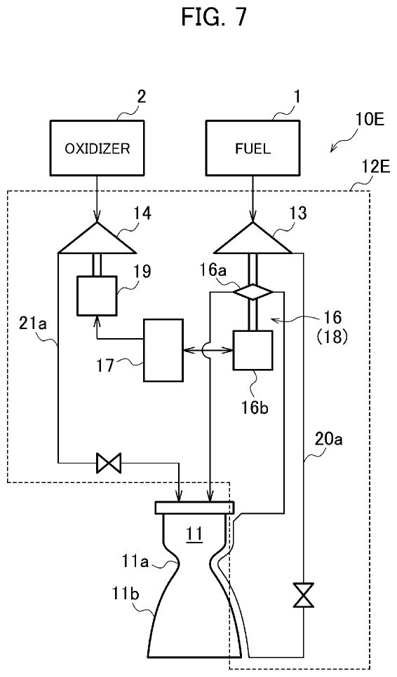

FIG. 7 is a schematic configuration diagram of the propulsion system 10E according to the fifth embodiment. As shown in FIG. 7, the propulsion system 10E includes a main combustion chamber 11 and a supply system 12E that supplies fuel and an oxidizer to the main combustion chamber 11. The supply system 12E includes a first pump 13, a second pump 14, a generator 16, a power storage device 17, a first electric motor 18, and a second electric motor 19. This configuration is identical to that of the propulsion system 10B according to the second embodiment.

However, the generator 16 of the fourth embodiment is applied to the generator 16 of the present embodiment. That is, the generator 16 of the fifth embodiment is a motor-generator that also serves as the first electric motor 18 that drives the first pump 13.

As with the second embodiment, the propulsion system 10E according to the present embodiment also adopts an expander cycle (full expander cycle) as an example of an operating cycle. Therefore, the fuel discharged from the second pump 14 cools the main combustion chamber 11, the throat 11a, and the nozzle 11b. Furthermore, the fuel passes through the turbine 16a in a gaseous state and is then supplied to the main combustion chamber 11.

In the fifth embodiment as well, the operating sequence shown in FIG. 2 can be executed. Although the power generation amount of the generator 16 varies depending on the set thrust, by ensuring a sufficient battery capacity in the power storage device 17, the first electric motor 18 (generator 16) and the second electric motor 19 can be driven at a desired rotational speed over the entire thrust range. Also, as with the first embodiment, the improvement in efficiency shown in FIG. 3 can be achieved. Furthermore, as with the fourth embodiment, the power generation unit 16b can also be made more compact.

### Sixth Embodiment

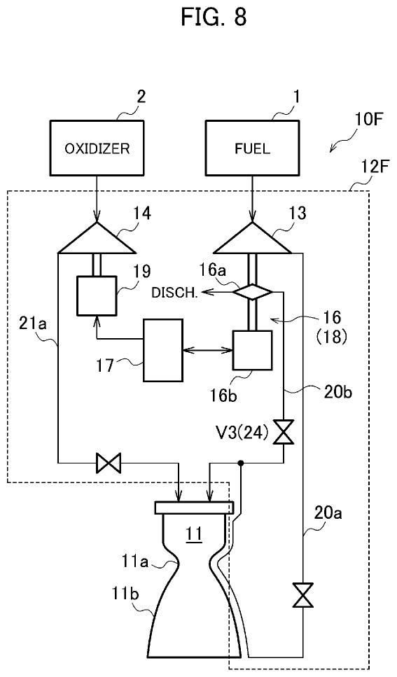

FIG. 8 is a schematic configuration diagram of the propulsion system 10F according to the sixth embodiment. As shown in FIG. 8, the propulsion system 10F includes a main combustion chamber 11 and a supply system 12F that supplies fuel and an oxidizer to the main combustion chamber 11. The supply system 12F includes a first pump 13, a second pump 14, a generator 16, a power storage device 17, a first electric motor 18, and a second electric motor 19. This configuration is identical to that of the propulsion system 10C according to the third embodiment.

However, the generator 16 of the fourth embodiment is applied to the generator 16 of the present embodiment. That is, the generator 16 of the sixth embodiment is a motor-generator that also serves as the first electric motor 18 that drives the first pump 13.

As with the third embodiment, the propulsion system 10E according to the present embodiment also adopts an expander bleed cycle as an example of an operating cycle. Therefore, the supply system 12F includes a path 20b branching from the fuel path 20a that has undergone regenerative cooling. The fuel flowing through the path 20b is supplied to the turbine 16a via valve V3 serving as the supply amount adjustment unit 24. The fuel discharged from the turbine 16a is discharged to the outside of the spacecraft or rocket on which the propulsion system 10E is mounted.

In the sixth embodiment as well, the operating sequence shown in FIG. 2 can be executed. However, it is possible to lower the back pressure of the turbine 16a more than in the fifth embodiment. Therefore, compared to the fifth embodiment, it becomes easier to increase the rotational speed of the turbine 16a, making it possible to improve the power generation performance of the generator 16 or to reduce the size of the generator 16. Also, since it is possible to drive the turbine 16a with fuel that has undergone regenerative cooling, the generator 16 can be made even more compact. Furthermore, as with the first embodiment, the improvement in efficiency shown in FIG. 3 can be achieved.

### Seventh Embodiment

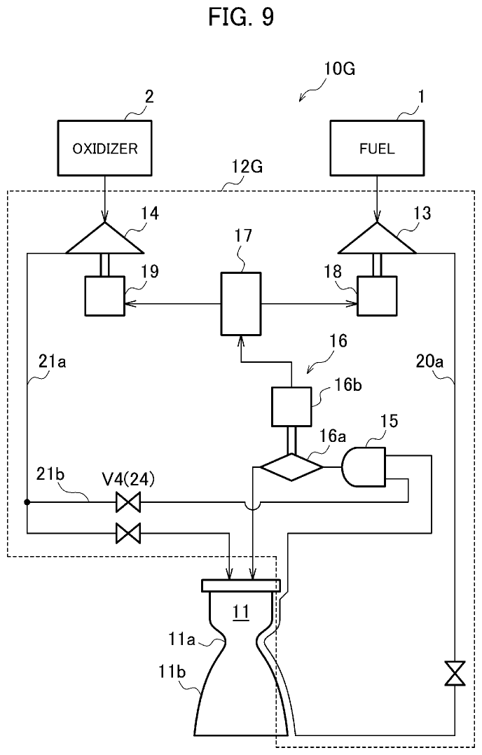

FIG. 9 is a schematic configuration diagram of the propulsion system 10G according to the seventh embodiment. As shown in FIG. 9, the propulsion system 10G includes a main combustion chamber 11 and a supply system 12G that supplies fuel and an oxidizer to the main combustion chamber 11. The supply system 12G includes a first pump 13, a second pump 14, a sub-combustion chamber (first sub-combustion chamber) 15, a generator 16, a power storage device 17, a first electric motor 18, and a second electric motor 19.

The propulsion system 10G adopts a staged combustion cycle as an example of an operating cycle. Therefore, the sub-combustion chamber 15 of the present embodiment is a so-called preburner, and generates fuel-rich combustion gas (pre-combustion gas). The generated combustion gas is supplied to a turbine (first turbine) 16a of the generator 16, causing the turbine 16a to rotate. The combustion gas that has passed through the turbine 16a is supplied to the main combustion chamber 11 and combusted therein together with the oxidizer discharged from the second pump. The amount of combustion gas supplied (generated) by the sub-combustion chamber 15 is adjusted by, for example, valve V4 serving as the supply amount adjustment unit 24 installed in the oxidizer path 21b.

As with each of the above-described embodiments, in the seventh embodiment as well, the operating sequence shown in FIG. 2 can be executed, and the improvement in efficiency shown in FIG. 3 can also be achieved. Note that, as with the fourth through sixth embodiments, the generator 16 may be a motor-generator that also serves as the first electric motor 18 that drives the first pump 13. That is, the turbine 16a may be drivingly connected to the power generation unit 16b and the second pump 14.

### Eighth Embodiment

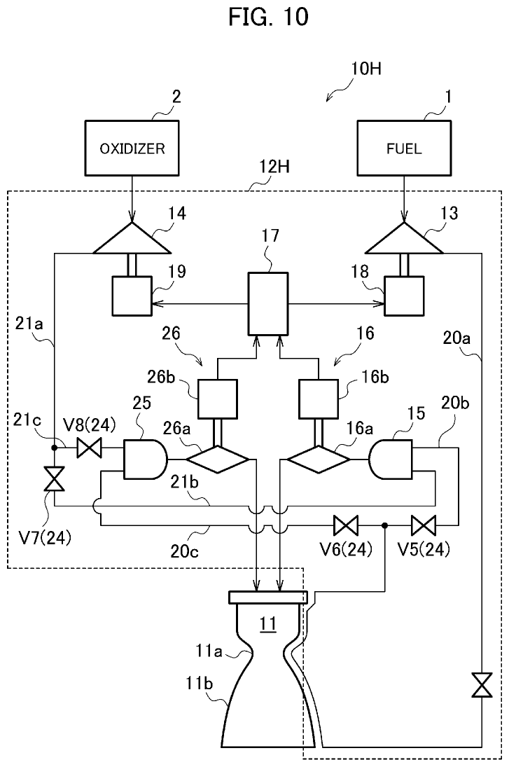

FIG. 10 is a schematic configuration diagram of the propulsion system 10H according to the eighth embodiment. As shown in FIG. 10, the propulsion system 10H includes a main combustion chamber 11 and a supply system 12H that supplies fuel and an oxidizer to the main combustion chamber 11. The supply system 12H includes a first pump 13, a second pump 14, a sub-combustion chamber (first sub-combustion chamber) 15, a sub-combustion chamber (second sub-combustion chamber) 25, a generator (first generator) 16, a generator (second generator) 26, a power storage device 17, a first electric motor 18, and a second electric motor 19.

The propulsion system 10H adopts a full-flow staged combustion cycle as an example of an operating cycle. Therefore, both the sub-combustion chamber 15 and the sub-combustion chamber 25 of the present embodiment are so-called preburners. The sub-combustion chamber 15 generates fuel-rich combustion gas, while the sub-combustion chamber 25 generates oxidizer-rich combustion gas.

The combustion gas generated by the sub-combustion chamber 15 is supplied to a turbine (first turbine) 16a of the generator 16, causing the turbine 16a to rotate. That is, the sub-combustion chamber 15 generates, from the fuel and oxidizer, a first working fluid that drives the turbine 16a. By the rotation of the turbine 16a, the power generation unit 16b generates electric power. The generated electric power is stored in the power storage device 17.

The combustion gas generated by the sub-combustion chamber 25 is supplied to a turbine (second turbine) 26a of the generator 26, causing the turbine 26a to rotate. That is, the sub-combustion chamber 25 generates, from the fuel and oxidizer, a second working fluid that drives the turbine 26a. By the rotation of the turbine 26a, the power generation unit 26b generates electric power. The generated electric power is stored in the power storage device 17.

The combustion gas that has passed through the turbine 16a is supplied to the main combustion chamber 11. The combustion gas that has passed through the turbine 26a is also supplied to the main combustion chamber 11. These combustion gases are mixed and combusted in the main combustion chamber 11.

The fuel path 20a in the supply system 12H branches into paths 20b and 20c. The path 20b is connected to the sub-combustion chamber 15 via valve V5. The path 20c is connected to the sub-combustion chamber 25 via valve V6. Similarly, the oxidizer path 21a branches into paths 21b and 21c. The path 21b is connected to the sub-combustion chamber 15 via valve V7. The path 20c is connected to the sub-combustion chamber 25 via valve V8.

Similarly to valves V1 to V4 described above, valves V5 to V8 may also function as the supply amount adjustment unit 24. In this case, valves V5 and V7 adjust the amount of the first working fluid supplied to the turbine 16a in accordance with the power generation amount set for the generator 16. Also, valves V6 and V8 adjust the amount of the second working fluid supplied to the turbine 26a in accordance with the power generation amount set for the generator 26.

As with each of the above-described embodiments, in the eighth embodiment as well, the operating sequence shown in FIG. 2 can be executed, and the improvement in efficiency shown in FIG. 3 can also be achieved. Note that, as with the fourth through sixth embodiments, the generator 16 may be a motor-generator that also serves as the first electric motor 18 that drives the first pump 13. That is, the turbine 16a may be drivingly connected to the power generation unit 16b and the first pump 13.

In the eighth embodiment, two generators can be operated. Therefore, the amount of power generation can be increased. Alternatively, it is also possible to reduce the size and weight of each generator relative to the required amount of electric power.

The present disclosure is not limited to the above-described embodiments, and is indicated by the description of the claims, and further includes all modifications within the meaning and scope equivalent to the description of the claims.

What is claimed is:

1. A propulsion system comprising:
a main combustion chamber; and
a supply system configured to supply fuel and an oxidizer to the main combustion chamber, wherein
the supply system includes:
a first pump configured to draw in the fuel and pressure-feeds it to the supply system;
a second pump configured to draw in the oxidizer and pressure-feeds it to the supply system;
a first generator including a first turbine driven by supply of a first working fluid derived from the fuel discharged from the first pump, or from the fuel discharged from the first pump and the oxidizer discharged from the second pump;
a power storage device configured to store electric power generated by the first generator;
a first electric motor configured to drive the first pump with electric power from the power storage device; and
a second electric motor configured to drive the second pump with electric power from the power storage device.

2. The propulsion system according to claim 1, wherein
the first generator is a motor-generator that also serves as the first electric motor, and
the first pump is drivingly connected to the first turbine of the first generator.

3. The propulsion system according to claim 1, comprising
a first sub-combustion chamber configured to generate the first working fluid from the fuel and the oxidizer.

4. The propulsion system according to claim 2, comprising
a first sub-combustion chamber configured to generate the first working fluid from the fuel and the oxidizer.

5. The propulsion system according to claim 1, wherein
the first working fluid is the fuel that has passed through regenerative cooling of the main combustion chamber.

6. The propulsion system according to claim 2, wherein
the first working fluid is the fuel that has passed through regenerative cooling of the main combustion chamber.

7. The propulsion system according to claim 1, comprising
a supply amount adjustment unit configured to adjust an amount of supply of the first working fluid to the first turbine in accordance with a power generation amount set for the first generator.

8. The propulsion system according to claim 2, comprising
a supply amount adjustment unit configured to adjust an amount of supply of the first working fluid to the first turbine in accordance with a power generation amount set for the first generator.

9. The propulsion system according to claim 3, wherein
control of ignition of the first sub-combustion chamber is performed independently of a timing of ignition of the main combustion chamber.

10. The propulsion system according to claim 4, wherein
control of ignition of the first sub-combustion chamber is performed independently of a timing of ignition of the main combustion chamber.

11. The propulsion system according to claim 7, wherein
the supply system includes:
a second sub-combustion chamber configured to generate a second working fluid from the fuel and the oxidizer; and
a second generator including a second turbine driven by supply of the second working fluid; and
the power storage device is configured to further store electric power generated by the second generator.

12. The propulsion system according to claim 8, wherein
the supply system includes:
a second sub-combustion chamber configured to generate a second working fluid from the fuel and the oxidizer; and
a second generator including a second turbine driven by supply of the second working fluid; and
the power storage device is configured to further store electric power generated by the second generator.
